(19) United States
(12) Patent Application Publication
(10) Pub. No.: US 2014/0313040 A1
(43) Pub. Date: Oct. 23, 2014

(54) Tactile and Visual Smoke Detector System

(71) Applicant: John Richard Wright, SR., Laurel, MD (US)

(72) Inventor: John Richard Wright, SR., Laurel, MD (US)

(21) Appl. No.: 14/259,679

(22) Filed: Apr. 23, 2014

Related U.S. Application Data
(60) Provisional application No. 61/815,064, filed on Apr. 23, 2013.

(51) Int. Cl. G08B 17/10

(52) U.S. Cl. CPC G08B 17/10
USPC 340/628

(57) ABSTRACT

A multi-feedback fire alarm system incorporating a wearable signal notification article is provided. The system detects fire threats and notifies users of specific threat types, even when the user is not in proximity to a detection unit. The system includes one or more detection units and one or more wearable signal notification articles. When the detection unit perceives danger, it sends an activation signal and an alarm signal to the signal notification article to alert the user that a threat is present. The wearable signal notification article comprises a flexible bracelet-style housing, and an integrated alert circuit module with a sensor chip, an antenna, multiple light sources, a vibrator, and a battery. Different illumination and vibration patterns occur depending upon the type of threat present and the associated alarm signal received. In this way, the device provides specific threat type information to hearing impaired users.

### CROSS REFERENCE TO RELATED APPLICATION

This application claims the benefit of U.S. Provisional Application No. 61/815,064 filed on Apr. 23, 2013, entitled “Smoke Detector for the Hearing Impaired.” The above identified patent application is herein incorporated by reference in its entirety to provide continuity of disclosure.

### BACKGROUND OF THE INVENTION

1. Field of the Invention

The present invention relates to a smoke detector system. More specifically, it relates to a system for providing visual and tactile feedback to a user whenever smoke, fire, or carbon monoxide is detected within a target environment. Users with hearing impairments that render the individual unable to perceive conventional alarm sounds will appreciate the multi-feedback system.

The dangers associated with fire are well known throughout the world. Fire can destroy homes and possessions as it consumes everything in its path. Smoke created by burning materials can damage other items or make it difficult to find an exit out of a burning building. If left unattended, fires and associated smoke can result in serious injury or even death.

Smoke detectors are an inexpensive and effective way of alerting building inhabitants of fire hazards. These simple devices contain carbon monoxide sensors and speakers preset to play a high-pitched sound at a high volume upon detection of smoke. The volume of emitted noise is very loud, so as to wake sleeping persons and alert persons in the area surrounding the building that there is a fire within. Some of these alarms illuminate a small warning light but most issue audible alerts only.

For the hearing impaired, conventional smoke alarms are not useful tools, because emitted noise is muffled or all-together blocked. Thus, building fires may pose a particularly serious threat for hearing impaired persons, because the impaired individuals will not hear the smoke alarms. If the hearing impaired person is asleep or otherwise occupied at the time the smoke alarm goes off, precious seconds may be wasted as the individual remains in the building.

A smoke detector system is needed that provides non-auditory alerts capable of perception by the hearing impaired. The present invention solves this problem by providing a smoke detector and associated wristband that vibrates and illuminates when smoke is detected.

2. Description of the Prior Art

Devices have been disclosed in the prior art that relate to fire detection devices. These include devices that have been patented and published in patent application publications. These devices generally relate to multi-feedback smoke detectors. The following is a list of devices deemed most relevant to the present disclosure, which are herein described for the purposes of highlighting and differentiating the unique aspects of the present invention, and further highlighting the drawbacks existing in the prior art.

Fire alarm systems that wirelessly communicate with remote devices have been discussed in several patents and patent publications. Hillman, U.S. Pat. No. 8,258,969, teaches a smoke alarm system that wirelessly communicates with flashlights. When a sensor within the smoke detector perceives the presence of smoke, a radio transceiver within the device transmits an activation signal to one or more flashlights. The flashlights will illuminate an integrated light source and may also emit a loud noise or begin to vibrate. The intended use of the flashlights is to aid persons within a burning building to see through smoke and darkened rooms so that users may find their way to safety. Although this system is useful in facilitating escape from burning buildings, the flashlights may not be sufficient to wake a hearing impaired person. The present invention solves this problem by providing a wearable wrist band.

Another smoke detection system employing remote alert devices is Sulkoski, U.S. Pat. No. 4,380,759. The Sulkoski device differs from the Hillman device in that the remote alarm receiver is a “beeper” as is conventional in the art of medical assistive devices. When smoke is detected, a signal is sent to the beeper that then begins to vibrate. Unlike the present invention, the beeper of Sulkoski is not a bracelet worn by a user. Nor does the beeper of Sulkoski have multiple illumination patterns to indicate different types of danger.

Alternatively, some multi-feedback detectors are incorporated into a single alert device. Henrie, U.S. Patent Application Publication 2006/0250261, teaches a bracelet style gas detector. The gas-detecting sensor and alert means are stored within the bracelet housing. The sensor may be configured to detect a variety of gas types including but not limited to carbon monoxide. When gas is detected, the bracelet may illuminate, vibrate, and/or sound an alarm. Unlike the present invention, this device does not connect with remote detectors, and is therefor only useful for indicating that gas is present in the immediately surrounding area.

These prior art devices have several known drawbacks. None of the devices disclosed in the prior art provide a variety of light patterns and visual indicators to users corresponding to the type of threat detected. The present invention provides a series of lights in a variety of colors, set to illuminate in different patterns depending upon the type of alarm signal received from the smoke detector. The present invention substantially diverges in design elements from the prior art and consequently it is clear that there is a need in the art for an improvement to existing multi-feedback fire alarm devices. In this regard the instant invention substantially fulfills these needs.

### SUMMARY OF THE INVENTION

In view of the foregoing disadvantages inherent in the known types of multi-feedback fire alarm devices now present in the prior art, the present invention provides a new threat specific alarm wherein the same can be utilized for providing convenience for the user when alerting hearing impaired users of danger.

The present system warns users of specific threats to their safety and well-being. One or more detector units are positioned throughout an environment such as an office building. Each detector unit is in wireless communication with one or more wristbands. To maximize safety, each wristband should be in communication with each detector, thereby ensuring that any alarm that sounds will alert all users as to the present danger. The detectors have integrated sensor chips that are capable of detecting high levels of carbon monoxide, excessive temperatures, and smoke particulate. When any detector perceives the presence of unusually high temperatures, levels of carbon monoxide, or smoke particulate, it transmits an activation signal along with an alarm signal. The activation signal is received by local wristbands, thereby initiating both tactile and visual feedback.

Wristbands are employed with the present system to provide users with an unobtrusive but easy to see warning device. Each wristband is capable of receiving transmissions, preferably via radio frequency communications. Further, each wristband has several illumination components, and a vibration component. Upon receipt of an activation signal the wristband initiates feedback. The type of feedback pattern initiated is dependent upon the alarm signal received. A different alarm signal is provided for each type of potential threat. For example, the presence of carbon monoxide may cause the wristband to illuminate blue lights and vibrate in an irregular pulsing pattern, while an alarm signal associated with fire may cause the lights to illuminate red and the vibrator to buzz steadily.

The system thus provides users with a different type of feedback depending upon the danger detected. Clearly visible illumination patterns and varied vibration patterns will make it easy for users to determine the type of threat present, and will aid them in forming a plan of action. In this way, the invention seeks to assist the hearing impaired with fire preparedness.

It is therefore an object of the present invention to provide a new and improved multi-feedback fire alarm system that has all of the advantages of the prior art and none of the disadvantages.

It is another object of the present invention to provide a system that offers threat specific visual and tactile feedback to users, thereby enabling them to make knowledgeable decisions about how to react to a threat.

Another object of the present invention is to provide a fire alarm system that is capable of alerting the hearing impaired to different types of danger.

A further object of the present invention is to provide a fire alarm system that wirelessly communications with one or more wristbands, so as to alert persons dispersed throughout a building.

Yet another object of the present invention is to provide a fire alarm system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of the general implementation of the preferred system of the present invention.

FIG. 2 shows a block diagram of an exemplary detector unit.

FIG. 3 shows block diagram of an exemplary wristband unit.

FIG. 4 shows a block diagram of the wristband unit, wherein a power source may be plugged into the bracelet to recharge the internal battery.

### DETAILED DESCRIPTION OF THE INVENTION

Reference is made herein to the attached drawings. Like reference numerals are used throughout the drawings to depict like or similar elements of the multi-feedback fire alarm system. For the purposes of presenting a brief and clear description of the present invention, the preferred embodiment will be discussed as used for alerting hearing impaired users about specific threats. The figures are intended for representative purposes only and should not be considered to be limiting in any respect.

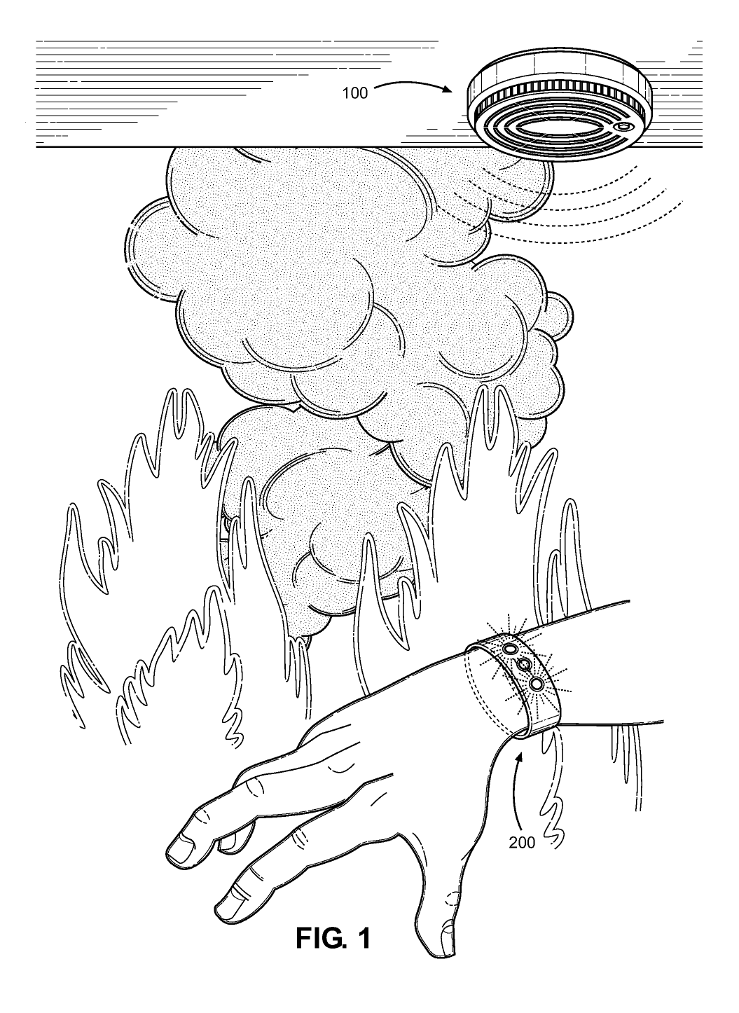

Referring now to FIG. 1, there is shown an exemplary implementation of the overall system. The system includes one or more detection units 100 capable of perceiving temperature changes, carbon monoxide levels, and airborne particulate concentration. Each of the one or more detection units is secured to a location throughout a target environment. Target environments may include buildings such as homes, office buildings, stables, or any other enclosed or semi-enclosed structure. Ideal locations for detection unit deployment are positions along ceilings or the upper portions of walls.

One or more wearable signal notification articles 200 are provided in the form of wristbands. These notification articles are in wireless communication with the detection units via radio frequency based communication protocols. When the detection unit perceives rapid increase in temperature, carbon monoxide levels, or particulate matter, it transmits signals to the notification articles. The wearable notification article then begins to vibrate and illuminate in predetermined patterns according to the type of threat detected by the detection unit. If a user is wearing the notification article at the time of activation, he or she will perceive tactile feedback from the vibration function, and visual feedback from the illumination means. By way of example, a detection unit perceiving rapid temperature change may transmit an alarm signal indicating that a fire risk is present. Upon receipt of the signal, the wristband may initiate a first vibration pattern and a first illumination pattern. These patterns are preset to correspond with specific alarm signals, thereby providing the user with feedback about the type of threat detected.

The system provides a low cost solution that can be used by people of all shapes and sizes, but is particularly useful for persons suffering from hearing loss. The wristband can be worn during daily activities and at night when the user is sleeping. The system is versatile and will be useful in situations aside from those described herein.

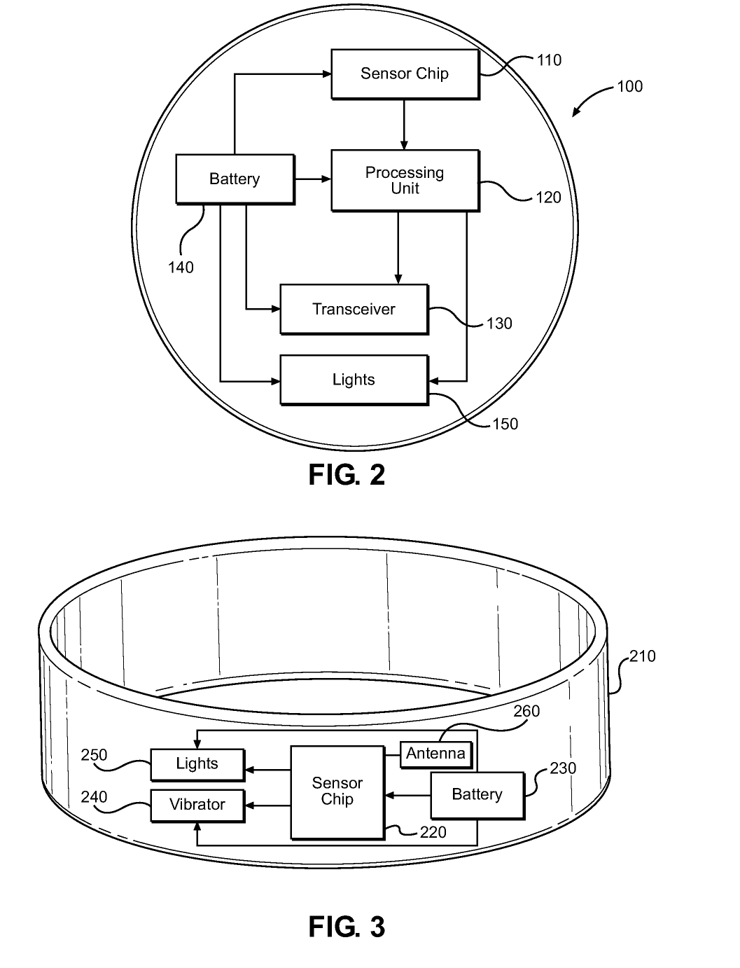

Turning now to FIG. 2 there is shown a general block diagram of an exemplary detection unit. The detection unit 100 has at least a sensor chip 110, a processing unit 120, a transceiver 130, a battery 140, a plurality of illuminators 150, and optional speakers. The illuminators and optional speakers may be connected to output terminals of the microprocessor, and the one or more sensor chips connected to the input terminals of the microprocessor. Circuit modules for detection units are known in the art, and the intimate details of such construction will not be discussed herein.

Further components of the detector unit will depend upon the implementation of the individual detectors. Photoelectric or ionization based smoke detection methods may be used. Thus, a detection light source will be included in photoelectric smoke detection units, and used to activate the sensor. Conversely, ionization based smoke detectors will require an ionization chamber in operative connection with the sensor chip and an associated ionization source. Triggering of a smoke detector sensor will signal the microprocessor to initiate alarms.

In addition to the smoke detector function, the detection unit also includes a carbon monoxide detector. As with the smoke detector implementation, the type of carbon monoxide detector implemented will determine the inclusion of additional parts. Biomimetic detectors will require the inclusion of a detection chamber holding a color-changing gel and associated sensor capable of monitoring the color shift in the gel. Metal oxide semiconductor detectors will require the inclusion of a silica chip and associated sensor for measuring resistance across the silica chip. Alternatively, an electrochemical sensor may be implemented, in which electrodes are immersed in a chemical solution, and an associated sensor measures resistance fluctuation within the solution. In any embodiment, activation of the sensor sends a signal to the microprocessor to initiate the alarm.

The detection unit also contains a heat activated fire detector. This may include the use of a glycerin-based gel that expands at temperatures approximately 135-165 degrees Fahrenheit. An associated sensor detects the expansion and signals the microprocessor.

The implementations described above are exemplary. The construction of smoke detectors, thermal activation fire detectors, and carbon monoxide detectors is well known in the art. Potential combinations of detectors and their implementations will be obvious to one of ordinary skill in the art.

Once a sensor perceives smoke, carbon monoxide, or fire-related temperatures, the microprocessor commences alarm activation. The illuminators, which are preferably different colors of light emitting diodes (LED) are illuminated according to the threat(s) detected. By way of example a first color of illuminator may be associated with fire, a second color associated with smoke, and a third color associated with carbon monoxide. If smoke and fire are detected, then the first and second illuminators will be activated. To aid in visual distinction of illuminators, it may be beneficial to place the differently colored illuminators at different points around the surface of the detection unit. To further aid in visual distinction each illuminator may be set to a different predetermined illumination pattern. A first illumination pattern may be associated with fire, a second illumination pattern associated with smoke, and a third illumination pattern associated with carbon monoxide detection. Illumination patterns may include blinking, steady illumination, pulsing lights, fading in and out of illumination, and the like.

Alarm activation may also include initiation of audible feedback from speakers if desired. The audible feedback should be louder than in conventional alarm systems to enable persons with reduced hearing capacity to detect the sound. Decibel levels of over 85 are preferred. The form of audible feedback may be dependent upon the detected threat. For illustrative purposes, a steady alarm sound may indicate fire, while a rapid beep indicates carbon monoxide, and a slow beep indicates smoke detection.

In addition to the detection unit alarm mechanisms activated, the detection will also activate one or more signal notification articles. These =notification articles are the wearable signal notification articles discussed above. Upon detecting a threat, the microprocessor initiates transmission of an activation signal first and an alarm signal second. Signals are transmitted via the transceiver unit and preferably employ the Bluetooth protocol. The range of this radio-frequency based protocol, makes it ideal for use within home environments because all detection units should be able to reach a signal notification unit regardless of position. Larger environments may require that detection units have integrated signal repeaters. Signal repeaters receive an alarm signal from another detection unit and transmit the alarm signal again as though it were their own. In either embodiment, the first signal sent is the activation signal, followed by the alarm signal. The activation signal instructs the wearable signal notification articles to “wake up” and prepare to receive an alarm signal. The alarm signal tells the notification article what type(s) of threat was detected. Based on the alarm signal received, the wearable signal notification article initiates visual and tactile feedback.

Referring now to FIG. 3, there is shown a general system diagram of the wearable signal notification article. The article 200 has a wristband-style outer housing 210 containing an integrated alert circuit module. The circuit module comprises a sensor chip 220, an antenna 260, a battery 230, at least three light sources 250, and a vibrator 240. Integrated alert circuit modules are known in the art of electrical engineering and the general construction of the present circuit module will be readily apparent to one of ordinary skill. Similarly, sensor chips are well known in the art and any such chip may be used so long as it has at least one input terminal and two output terminals. The antenna is operatively connected to the sensor chip input and the light source(s) and vibrator are operatively connected to the sensor chip outputs.

The antenna 260 will vary slightly in length according to the desired range of the device, and the type of wireless signal employed. In one embodiment a small antenna and the sensor chip 220 may be integrated into the surface of a small circuit board. In another embodiment the antenna may be composed of one or more conductive wires with a length substantially greater than that of the sensor ship. The wire(s) will be operatively connected to the sensor chip and may extend in parallel along the length of the outer housing 210. Flexibility of the wristband style outer housing is an important feature of the present invention, thus the antenna should not extend for more than half of the length of the housing. Depending on the embodiment of the invention, the antenna may range in length from a few millimeters to a few inches, so long as the length of the antenna does not impede the flexibility of the housing.

When the antenna detects an incoming activation signal and subsequent alarm signal, the signal is sent to the sensor chip via the input terminal. The sensor chip then activates one of the light sources 250 along with the vibrator 240 via the output terminals. In a preferred embodiment, the light source is one or more high intensity light emitting diodes (LEDs). High intensity LEDs provide a highly visible point light source that requires a small amount of energy. They are well suited to use in the present invention because they will not drain the battery significantly during regular use. A variety of LED colors are available, and the specific color combinations and arrangement thereof may be determined during manufacturing. To increase visibility of the LEDs, part or all of the bracelet housing should be opaque or semi-translucent. A combination of solid and translucent material may be used in order to create aesthetically pleasing patterns along the surface of the bracelet. At least three different light colors should be included in the implementation of the device so that each color may be illuminated individually or in combination, depending upon the alarm signal received. Additionally, the different colors of LEDs may be set to illuminate in different patterns, such that each color has a different illumination pattern. In this way, the device provides both color coded and pattern recognition visual feedback.

In addition to the lights, a small vibrator 240 is included. Shaftless vibration motors are preferred due to the thinness of the wristband housing. Vibration motors such as coin and pancake motors are well suited for use in the signal notification device. When the sensor chip activates the vibrator motor, the entire device will begin to vibrate. Vibrations may come in varied pulses, or in a steady vibration pattern according to the type of alarm signal received by the signal notification article. Instructions of this nature are contained in the sensor chip's embedded logic. The vibration mechanism may include its own circuitry, independent of the rest of the integrated alert circuit module except for the connection to the sensor chip output terminal. Alternatively, the integrated alert circuit module may be designed such that the sensor chip is integrated into the vibration motor circuitry. The precise implementation of the circuit module will depend on the size of the outer housing and various economic factors. Thus, it is left to one of ordinary skill to determine the most appropriate configuration of the elements of the integrated alert circuit module.

Small batteries with a long life are present in the art. Cadmium, lithium, and lithium ion batteries are commonly used to power consumer electronics and small devices. The battery 230 of the present invention is electrically connected to the light source(s) 150, the vibrator 240, and the sensor chip 220. Any battery suitable for powering these elements may be used in the present invention.

The entire integrated alert circuit module is contained within an outer housing 210. The housing is a wristband that is preferably constructed from a waterproof material. The overall thickness and length of the housing will depend on the size of the elements of the integrated alert circuit module, but it should be understood that the wristband should be thin and lightweight. Bulky or heavy accessories are not desirable during physical activities or sleep, making a lightweight structure an important aspect of the present invention.

In a preferred embodiment, the components of the alert circuit module are enclosed in the outer housing, which may be molded around them, either with or without an internal cavity. Molding the housing around the circuit module restricts movement of component parts, making it less likely that they will be damaged due to jostling.

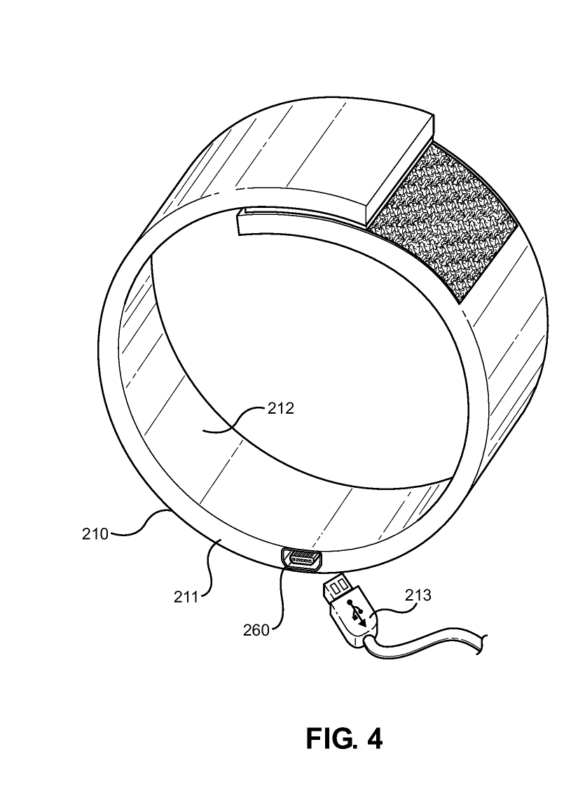

Another view of the wearable signal notification article is shown in FIG. 4. The outer housing 210 is shown from the side, with both the outer surface 211 and inner surface 212 viewable. The housing is flexible to permit the band to wrap around a user's wrist. Users of different sizes can be accommodated by a single device because the band's diameter can be modified via an attachment means such as hook and loop fasteners. Flexibility and elasticity also prevent the band from breaking if it becomes snagged on clothing or other objects while in use.

In one embodiment, shown in FIG. 4 the device has a small external port 260 disposed along a side or the outer surface of the bracelet housing 210. This port is operatively connected to the internal battery. External power sources are connected to the device via the external port to facilitate battery recharging. A small plug may be attached to and loosely extend from the outer housing near the external port. The plug is preferably made of the same material as the outer housing and is sized to fit within the external port to seal it when it is not in use. The plug is an optional feature, and is useful in preventing dirt and debris from getting into the external port. The plug may be left off of some devices and the port left exposed. In all embodiments the device and its internal components will have a waterproofed coating to ensure that submerging the device in water does not allow interior components to experience water damage. Depicted in FIG. 4, is an external port in the form of a mini-universal serial bus (USB) port with an accompanying mini-USB cord 213. This is for exemplary purposes only as any power transfer connection known in the art of small electronics may be employed.

The present invention is a system that incorporates both a wearable signal notification article and detection unit to provide an alarm system to hearing impaired users. The invention as a whole provides users with a way to remain aware of potential threats, despite being distant from a detector, or having limited hearing abilities. Users may don the article to receive visual and tactile feedback whenever an associated danger is detected by the one or more detection units. Visual feedback may come from individual light sources or illumination patterns. Tactile feedback is generated by a vibrating motor that vibrates the device when incoming alert signals are received. The wearable article is a wristband that may come in many colors and sizes but should be constructed of a durable waterproof material. In this way, the device is well suited for use by sleepers as well as participants in physical activities.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-feedback alarm system, comprising:
a detection unit having at least a sensor chip, a microprocessor, a transceiver, at least three light sources, and a battery, wherein said detection unit is capable of detecting smoke, fire, and carbon monoxide in an environment, and wherein said detection unit is adapted to transmit an activation signal and an alarm signal;
a signal notification article having a housing that houses a sensor chip, an antenna, a battery, three or more light sources, and a vibration mechanism, and wherein said signal notification article is adapted to receive said activation signal and said alarm signal from said detection unit;
said alarm signal conveys information to said signal notification device regarding the type of threat detected by said detection unit;
said activation signal initiating activation of said signal notification article and said alarm signal initiating a predetermined illumination and vibration pattern.

2. The system of claim 1, wherein each of said light sources of said detection unit are differently colored high intensity light emitting diodes and each of said light sources of said signal notification articles are differently colored high intensity light emitting diodes.

3. The system of claim 1, wherein said light sources of said detection unit include three colors that correspond to three colors of said light sources disposed within said signal notification article.

4. The system of claim 1, wherein said predetermined illumination and vibration pattern is any combination of one or more illumination and vibration patterns, wherein each pattern is associated with a specific type of threat detected by said detection unit.

5. The system of claim 1, wherein said housing of said signal notification article is a wristband.

6. The system of claim 1, wherein said detection unit further comprises:
speakers capable of playing audible feedback at volumes greater than 85 decibels.

7. A multi-feedback alarm system, comprising:
a plurality of detection units having at least a sensor chip, a microprocessor, a transceiver, at least three light sources, and a battery, wherein said detection unit is capable of detecting smoke, fire, and carbon monoxide in an environment, and wherein said detection unit is adapted to transmit an activation signal and an alarm signal;
one or more signal notification articles having a housing that houses a sensor chip, an antenna, a battery, three or more light sources, and a vibration mechanism, and wherein said signal notification article is adapted to receive said activation signal and said alarm signal from any of said detection units;
said alarm signal conveys information to said signal notification device regarding the type of threat detected by said detection unit;
said activation signal initiating activation of said signal notification article and said alarm signal initiating a predetermined illumination and vibration pattern.

8. The system of claim 7, wherein each of said light sources of said detection unit are differently colored high intensity light emitting diodes and each of said light sources of said signal notification articles are differently.

9. The system of claim 7, wherein said light sources of said detection units include three colors that correspond to three colors of said light sources disposed within said signal notification article.

10. The system of claim 7, wherein said predetermined illumination and vibration pattern is any combination of one or more illumination and vibration patterns, wherein each pattern is associated with a specific type of threat detected by said detection units.

11. The system of claim 7, wherein said housing of said signal notification article is a wristband.

12. The system of claim 7, wherein said detection unit further comprises:
speakers capable of playing audible feedback at volumes greater than 85 decibels.
